(19) United States
(12) Patent Application Publication
(10) Pub. No.: US 2026/0045868 A1
(43) Pub. Date: Feb. 12, 2026

(54) ACTIVE DISCHARGE METHOD AND POWER CONVERSION SYSTEM

(71) Applicant: Renesas Electronics Corporation, Tokyo (JP)

(72) Inventor: Kazuhiro KAMIYA, Tokyo (JP)

(21) Appl. No.: 19/266,357

(22) Filed: Jul. 11, 2025

(30) Foreign Application Priority Data
Aug. 8, 2024 (JP) 2024-133189

(51) Int. Cl. H02M 1/32; B60L 50/60; B60L 53/22; B60L 58/10; H02M 1/08; H02M 3/335

(52) U.S. Cl. CPC H02M 1/322; B60L 50/60; B60L 53/22; B60L 58/10; H02M 1/08; H02M 3/33569; B60L 2210/10

(57) ABSTRACT

An active discharge method is executed during a discharge period after inputting a discharge instruction signal instructing discharge of a bus capacitor. The active discharge method is a method of generating a first PWM signal having a discharge switching frequency different from a normal switching frequency, and a second PWM signal that is a complementary signal to the first PWM signal, for a gate driver for a high side and a gate driver for a low side.

### CROSS-REFERENCE TO RELATED APPLICATIONS

The disclosure of Japanese Patent Application No. 2024-133189 filed on Aug. 8, 2024 including the specification, drawings and abstract is incorporated herein by reference in its entirety.

### BACKGROUND

The present invention relates to an active discharge method and a power conversion system.

There are disclosed techniques listed below.

### [Patent Document 1] Japanese Unexamined Patent Application Publication No. 2024-64106

Patent Document 1 illustrates a gate driver IC including an isolator. The isolator includes a primary coil that is driven by the transmitting circuit. The transmitting circuit uses an N-channel MOS transistor with a load resistor and a source resistor inserted therein to output a high-speed, large-current pulse.

### SUMMARY

Generally, active discharge is known as a function to discharge the voltage of a bus capacitor to a safe level. An electric vehicle, for example, unlike a conventional gasoline-powered vehicle, is equipped with many high-voltage components. For this reason, an electric vehicle requires safety measures to protect the human body from high-voltage components in the event of a vehicle collision, for example. For one, an electric vehicle uses active discharge to discharge the bus capacitor that holds the battery voltage at a vehicle collision.

One possible method of implementing active discharge is to pass a through-current through an existing power transistor. Alternatively, it is conceivable to add a circuit for active discharge. However, such methods are regarded as potentially damaging to the power transistor and likely to increase costs.

An embodiment described below has been made in consideration of the above, and other objects and novel features will become apparent from the description of the present specification and the accompanying drawings.

According to one embodiment, a power conversion system includes a first power supply wiring that supplies a high-potential side power supply voltage, a second power supply wiring that supplies a low-potential side power supply voltage, a bus capacitor, first and second power transistors, and first and second gate drivers. The bus capacitor is connected between the first power supply wiring and the second power supply wiring. The first power transistor is connected between the first power supply wiring and an output node. The second power transistor is connected between the second power supply wiring and the output node. The first gate driver performs switching control of the first power transistor with a first drive signal based on a first PWM signal. The second gate driver performs switching control of the second power transistor with a second drive signal based on a second PWM signal. Here, the active discharge method in a power conversion system is executed during a discharge period after inputting a discharge instruction signal instructing discharge of the bus capacitor. The active discharge method is a method of generating a first PWM signal having a discharge switching frequency different from a normal switching frequency, and a second PWM signal that is a complementary signal to the first PWM signal, for the first gate driver and the second gate driver.

According to one embodiment, a bus capacitor can be safely discharged without increasing costs.

### BRIEF DESCRIPTION OF THE DRAWINGS

FIG. 1 is a schematic diagram illustrating a configuration example of a main part of a power conversion system according to one embodiment.

FIG. 2 is a schematic diagram illustrating a configuration example of a vehicle to which the power conversion system in FIG. 1 is applied.

FIG. 3 is a schematic diagram illustrating a configuration example of an inverter device to which the power conversion system in FIG. 1 is applied.

FIG. 4 is a flowchart illustrating an example of a schematic process of a controller in FIG. 1 and FIG. 3.

FIG. 5 is a supplementary diagram to FIG. 4, and is a timing chart illustrating an example of main signals transmitted within the power conversion system.

FIG. 6 is a schematic diagram illustrating the operation principle of active discharge performed during the discharge period in FIG. 5.

FIG. 7A is a cross-sectional view illustrating a configuration example of a package in which a gate driver is mounted in FIG. 1.

FIG. 7B is a cross-sectional view illustrating a configuration example of a package different from that in FIG. 7A.

FIG. 8A is a schematic diagram illustrating an example of an active discharge method in the power conversion system according to a first comparative example.

FIG. 8B is a schematic diagram illustrating an example of an active discharge method in the power conversion system according to a second comparative example.

FIG. 9 is a schematic diagram illustrating an example of a mounting method in a power conversion system according to a third comparative example.

### DETAILED DESCRIPTION

In the following embodiment, for the sake of convenience, the description may be divided into a plurality of sections or embodiments where appropriate. However, unless explicitly stated otherwise, such divisions are not mutually exclusive; rather, in that one may be a modification, a detail, or a supplementary explanation of the other, either in whole or in part. In the following embodiment, when referring to the number of elements (including quantities, numerical values, amounts, ranges, etc.), unless explicitly stated otherwise or unless it is clearly limited to a specific number by principle, the number is not to be construed as limiting, and may be more or less than the stated number.

Furthermore, in the following embodiment, it goes without saying that the constituent elements (including element steps, etc.) are not necessarily essential, unless explicitly stated otherwise or unless they are clearly considered essential by principle. Similarly, in the following embodiment, references to the shapes, positional relationships, etc. of constituent elements are intended to include those that are substantially similar or approximate thereto, unless explicitly stated otherwise or unless it is clearly not so from by principle. The same applies to the above numerical values and ranges.

In the following embodiment, a p-channel Metal Oxide Semiconductor Field Effect Transistor (MOSFET) and an n-channel MOSFET are also referred to as a pMOS transistor and an nMOS transistor, respectively. Hereinafter, an embodiment of the present invention will be described in detail with reference to the drawings. In all the drawings for explaining the embodiment, the same reference numerals are basically assigned to the same components, and repeated explanations thereof are omitted.

### Configuration of Power Conversion System

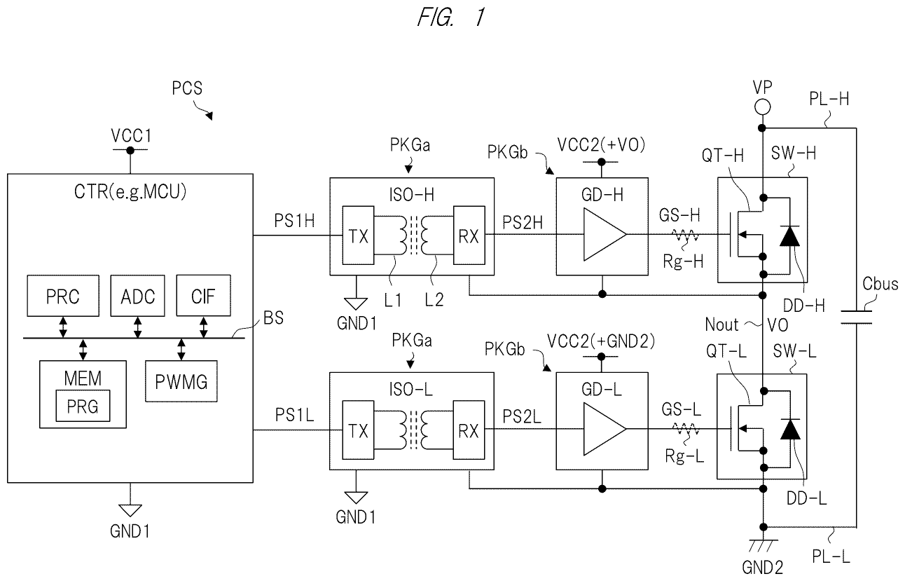

FIG. 1 is a schematic diagram illustrating a configuration example of a main part of a power conversion system according to one embodiment. A power conversion system PCS illustrated in FIG. 1 includes a controller CTR, isolators ISO-H and ISO-L, gate drivers GD-H and GD-L, switching elements SW-H and SW-L, a high-potential side power supply wiring PL-H and a low-potential side power supply wiring PL-L, and a bus capacitor Cbus. The high-potential side power supply wiring (first power supply wiring) PL-H supplies a power supply voltage (high-potential side power supply voltage) VP. The low-potential side power supply wiring (second power supply wiring) PL-L supplies a second ground voltage (low-potential side power supply voltage) GND2. The bus capacitor Cbus is connected between the high-potential side power supply wiring PL-H and the low-potential side power supply wiring PL-L, and maintains a power supply voltage VP. The power supply voltage VP has a voltage value of, for example, several hundred V or higher, with reference to the second ground voltage GND2.

The switching element SW-H provided on the high side, in other words the upper arm, includes a power transistor (first power transistor) QT-H and a body diode DD-H. Similarly, the switching element SW-L provided on the low side, in other words the lower arm, includes a power transistor (second power transistor) QT-L and a body diode DD-L. The power transistors QT-H and QT-L are, for example, n-channel MOSFETs formed on an Si substrate or a SiC substrate. Not limited to this, the power transistors QT-H and QT-L may also be an Insulated Gate Bipolar Transistor (IGBT) or a GaN FET, for example.

In the example illustrated in FIG. 1, the power transistors QT-H and QT-L are n-channel MOSFETs. The power transistor QT-H is connected between the high-potential side power supply wiring PL-H and an output node Nout. The power transistor QT-L is connected between the Low-potential side power supply wiring PL-L and the output node Nout. The power transistors QT-H and QT-L supply power to an external load such as a motor (not illustrated) that is connected to the output node Nout.

More specifically, the source and the drain of the power transistor QT-H are connected to the output node Nout and the high-potential side power supply wiring PL-H, respectively. The source and the drain of the power transistor QT-L are connected to the low-potential side power supply wiring PL-L and the output node Nout, respectively. The body diode DD-H is connected between the source and the drain of the power transistor QT-H, with the source side serving as the anode. Similarly, the body diode DD-L is connected between the source and the drain of the power transistor QT-L, with the source side serving as the anode.

The gate driver (first gate driver) GD-H performs switching control of the power transistor QT-H with a gate drive signal (first drive signal) GS-H. The gate driver GD-H is supplied with an output voltage VO at the output node Nout and a power supply voltage VCC2 that is generated with reference to the output voltage VO. Similarly, the gate driver (second gate driver) GD-L performs switching control of the power transistor QT-L with a gate drive signal (second drive signal) GS-L. The gate driver GD-L is supplied with a second ground voltage GND2 and a power supply voltage VCC2 that is generated with reference to the second ground voltage GND2. For example, the power supply voltage VCC2 is 15 V or 20 V, or the like. Therefore, when the power transistors QT-H and QT-L are driven to on, a voltage of 15 V or 20 V, or the like, is input between their respective gates and sources. On the other hand, although not illustrated, when the power transistors QT-H and QT-L are driven to off, a negative voltage (−VEE) may be input between their respective gates and sources, so as to prevent unintended arc discharge. In this case, for example, a voltage that is several volts lower than the output voltage VO is input to the gate of the power transistor QT-H. A voltage that is several volts lower than the second ground voltage GND2 is input to the gate of the power transistor QT-L.

The controller CTR is, for example, a microcontroller unit (MCU), a system on chip (SoC) or the like. In this case, the controller CTR includes, for example, a processor PRC, a memory MEM, an analog-to-digital converter ADC, an external communication interface CIF, a Pulse Width Modulation (PWM) signal generator PWMG, and a bus BS connecting these components. The processor PRC includes a Central Processing Unit (CPU) and may also include a Digital Signal Processor (DSP) and the like. The memory MEM is configured, for example, with a combination of a volatile memory such as an SRAM and a non-volatile memory such as a flash memory.

The memory MEM stores a control program PRG. The processor PRC executes the control program PRG. Accordingly, the controller CTR generates a PWM signal (first PWM signal) PS1H for the gate driver GD-H, and a PWM signal (second PWM signal) PS1L for the gate driver GD-L, based on the control program PRG. The controller CTR performs switching control of the power transistors QT-H and QT-L via the isolators ISO-H and ISO-L and the gate drivers GD-H and GD-L to control the power supplied to the external load.

As an example, the controller CTR performs feedback control of the external load based on the control program PRG. In this case, the controller CTR acquires a detection signal from the external load or the like, that is, a feedback value, as a digital value using the analog-to-digital converter ADC. The controller CTR sets the duty ratio of the PWM signals PS1H and PS1L so that the error between the feedback value and a predetermined target value approaches zero. Then, the controller CTR uses the PWM signal generator PWMG to generate and output the PWM signals PS1H and PS1L having the set duty ratio.

The controller CTR is supplied with a first ground voltage GND1 and a power supply voltage VCC1 that is generated with reference to the first ground voltage GND1. The power supply voltage VCC1 is, for example, 5 V. Furthermore, the controller CTR is not limited to a microcontroller unit or the like, but may be a programmable logic device such as a Field Programmable Gate Array (FPGA), an Application Specific Integrated Circuit (ASIC), or the like.

The isolator (first isolator) ISO-H transmits the PWM signal PS1H from the controller CTR to the gate driver GD-H while isolating the controller CTR from the gate driver GD-H. Specifically, the isolator ISO-H converts the PWM signal PS1H that transitions with reference to the first ground voltage GND1 into a PWM signal PS2H that transitions with reference to the ground voltage in the gate driver GD-H, that is, the output voltage VO.

Similarly, the isolator (second isolator) ISO-L transmits the PWM signal PS1L from the controller CTR to the gate driver GD-L while isolating the controller CTR from the gate driver GD-L. Specifically, the isolator ISO-L converts the PWM signal PS1L that transitions with reference to the first ground voltage GND1 into a PWM signal PS2L that transitions with reference to the second ground voltage GND2 in the gate driver GD-L.

The gate driver GD-H receives the PWM signal PS2H from the isolator ISO-H, and performs switching control of the power transistor QT-H based on the PWM signal PS2H, which, in turn, is based on the PWM signal PS1H from the controller CTR. Similarly, the gate driver GD-L receives the PWM signal PS2L from the isolator ISO-L, and performs switching control of the power transistor QT-L based on the PWM signal PS2L, which, in turn, is based on the PWM signal PS1L from the controller CTR.

The isolators ISO-H and ISO-L are, for example, digital isolators that transmit signals using magnetic coupling. In this case, each of the isolators ISO-H and ISO-L includes, for example, a primary coil L1, a secondary coil L2, a transmitting circuit TX, and a receiving circuit RX. Taking the isolator ISO-H as an example, the transmitting circuit TX drives the primary coil L1 based on the PWM signal PS1H. The receiving circuit RX outputs the PWM signal PS2H by detecting the signal magnetically coupled to the secondary coil L2. However, the isolators ISO-H and ISO-L are not limited to such a magnetic coupling type, and may be configured using, for example, a capacitive coupling type or the like. Although details will be described later, the control program PRG includes a program for performing active discharge. Although not necessarily limited thereto, each of the isolators ISO-H and ISO-L is mounted in a package PKGa. Each of the gate drivers GD-H and GD-L is mounted in a package PKGb. That is, the gate driver GD-H and the isolator ISO-H are mounted in separate packages PKGb and PKGa. Similarly, the gate driver GD-L and the isolator ISO-L are mounted in separate packages PKGb and PKGa.

### Application to Vehicle

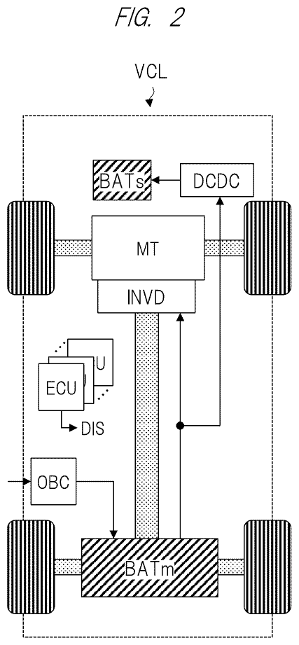

FIG. 2 is a schematic diagram illustrating a configuration example of a vehicle VCL to which the power conversion system PCS in FIG. 1 is applied. The vehicle VCL illustrated in FIG. 2 is, for example, an automobile such as a Hybrid Electric Vehicle (HEV), a Plug in Hybrid Vehicle (PHV), or a Battery Electric Vehicle (BEV). The vehicle VCL includes a main battery BATm, a motor MT and an inverter device INVD, a sub battery BATs and a DC-DC converter DCDC, an on-board charger OBC, and a plurality of electronic control units ECU.

The main battery BATm generates a power supply voltage of 400 V or higher, for example, 400 V, 800 V, or 1200 V. The motor MT is, for example, a three-phase motor that drives the vehicle VCL. The inverter device INVD converts DC power from the main battery BATm into three-phase (u-phase, v-phase, w-phase) AC power, and drives the motor MT with the AC power. The sub battery BATs generates a power supply voltage of, for example, 12 V. The DC-DC converter DCDC, for example, converts a voltage value of the main battery BATm into a voltage value of the sub battery BATs, and charges the sub battery BATs using the converted voltage value.

The on-board charger OBC converts AC power obtained from a charging station into DC power and charges the main battery BATm. The plurality of electronic control units ECU controls the entire vehicle VCL based on, for example, detection signals from various sensors. As one of these, an electronic control unit ECU generates and outputs a discharge instruction signal DIS that instructs discharging the bus capacitor Cbus illustrated in FIG. 1. Specifically, for example, when a collision of the vehicle VCL is detected by a collision detection sensor, the electronic control unit ECU generates a discharge instruction signal DIS as one of the collision detection signals.

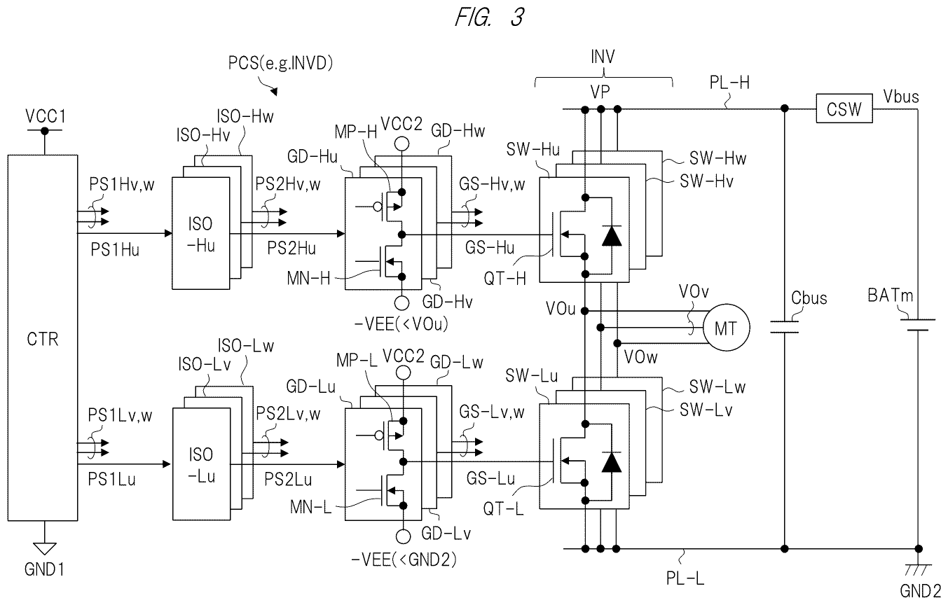

Here, the power conversion system PCS illustrated in FIG. 1 is applied to, for example, the inverter device INVD, the DC-DC converter DCDC, the on-board charger OBC, or the like. For example, a case is assumed in which the power conversion system PCS is applied to the inverter device INVD. FIG. 3 is a schematic diagram illustrating a configuration example of the inverter device INDV to which the power conversion system PCS in FIG. 1 is applied.

As illustrated in FIG. 3, the switching elements SW-H and SW-L, the gate drivers GD-H and GD-L, and the isolators ISO-H and ISO-L illustrated in FIG. 1 are provided for each of the three phases (u-phase, v-phase, w-phase) that constitute the inverter device INVD. Meanwhile, the controller CTR is provided in common to all three phases. Three-phase output voltages VO (u, v, w) from an inverter INV constituted by the three-phase switching elements SW-H and SW-L are applied to the motor MT, which is an external load of the inverter device INVD.

Specifically, the controller CTR generates and outputs three-phase PWM signals PS1H (u, v, w) via three-phase isolators ISO-H (u, v, w) to three-phase gate drivers GD-H (u, v, w) provided on the high side. Also, the controller CTR generates and outputs three-phase PWM signals PS1L (u, v, w) via three-phase isolators ISO-L (u, v, w) to three-phase gate drivers GD-L (u, v, w) provided on the low side.

The three-phase isolators ISO-H (u, v, w) provided on the high side input the three-phase PWM signals PS1H (u, v, w) and output the three-phase PWM signals PS2H (u, v, w). Similarly, the three-phase isolators ISO-L (u, v, w) provided on the low side input the three-phase PWM signals PS1L (u, v, w) and output the three-phase PWM signals PS2L (u, v, w).

The three-phase gate drivers GD-H (u, v, w) provided on the high side perform switching control of the three-phase switching elements SW-H (u, v, w) with three-phase gate drive signals GS-H (u, v, w) based on the input three-phase PWM signals PS2H (u, v, w). Here, each of the three-phase gate drivers GD-H (u, v, w) includes a pMOS transistor MP-H and an nMOS transistor MN-H. For example, a case is assumed in which the gate of the power transistor QT-H included in the u-phase switching element SW-Hu is driven using the u-phase gate driver GD-Hu.

In this case, the pMOS transistor MP-H pulls up the gate voltage of the power transistor QT-H to the power supply voltage VCC2. The power supply voltage VCC2 is set with reference to the u-phase output voltage VOu. On the other hand, the nMOS transistor MN-H pulls down the gate voltage of the power transistor QT-H to a negative voltage (−VEE). The negative voltage (−VEE) is set to, for example, a voltage that is several volts or more lower than the u-phase output voltage VOu. It is also possible to replace the pMOS transistor MP-H with a combination of an nMOS transistor and a boosting power supply such as a charge pump that drives the gate of the nMOS transistor.

The three-phase gate drivers GD-L (u, v, w) provided on the low side perform switching control of the three-phase switching elements SW-L (u, v, w) with three-phase gate drive signals GS-L (u, v, w) based on the input three-phase PWM signals PS2L (u, v, w). Here, each of the three-phase gate drivers GD-L (u, v, w) also includes a pMOS transistor MP-L and an nMOS transistor MN-L. For example, a case is assumed in which the gate of the power transistor QT-L included in the u-phase switching element SW-Lu is driven using the u-phase gate driver GD-Lu.

In this case, the pMOS transistor MP-L pulls up the gate voltage of the power transistor QT-L to the power supply voltage VCC2. The power supply voltage VCC2 is set with reference to the second ground voltage GND2. On the other hand, the nMOS transistor MN-L pulls down the gate voltage of the power transistor QT-L to a negative voltage (−VEE). The negative voltage (−VEE) is set to, for example, a voltage that is several volts or more lower than the second ground voltage GND2. The pMOS transistor MP-L can also be configured, with a combination of an nMOS transistor and a boosting power supply.

In addition, the three-phase switching elements SW-H (u, v, w) provided on the high side is supplied with power supply voltage VP via the high-potential side power supply wiring PL-H. The three-phase switching elements SW-L (u, v, w) provided on the low side is supplied with the second ground voltage GND2 via the low-potential side power supply wiring PL-L. Here, the power supply voltage VP and the second ground voltage GND2 are generated by the main battery BATm.

In the example illustrated in FIG. 3, a contactor CSW, in other words a switch, is inserted in a power supply path between the main battery BATm and the bus capacitor Cbus in the high-potential side power supply wiring PL-H. The main battery BATm generates a bus voltage Vbus. When controlled to turn on, the contactor CSW supplies the bus voltage Vbus to the bus capacitor Cbus as the power supply voltage VP. When detecting a collision, the vehicle VCL illustrated in FIG. 2 controls the contactor CSW to turn off and then outputs a discharge instruction signal DIS. Accordingly, active discharge is performed while the bus capacitor Cbus is isolated from the main battery BATm.

Also, the DC-DC converter DCDC in FIG. 2 can be configured, for example, with a full-bridge or half-bridge LLC converter or the like. For example, a case is assumed in which a full-bridge LLC converter is applied to the power conversion system PCS illustrated in FIG. 1. In this case, the switching elements SW-H and SW-L, the gate drivers GD-H and GD-L, and the isolators ISO-H and ISO-L are provided for each of the two phases that drive the primary side of a transformer. Meanwhile, the controller CTR is provided in common to the two phases. Here, the power supply voltage VP is generated by the main battery BATm. The two-phase output nodes Nout are connected to both ends of a primary coil of the transformer, respectively. Thus, in particular, in the power conversion system PCS to which the high power supply voltage VP is supplied from the main battery BATm, active discharge is required to ensure safety. Active discharge is a function for discharging the bus capacitor Cbus within a predetermined discharge time in response to a discharge instruction signal DIS such as a collision detection signal. The discharge time is set by the laws and regulations of each country. As an example, the inverter device INVD is required to discharge the power supply voltage VP to 60 V or lower within 3.0 s in response to the discharge instruction signal DIS.

### Active Discharge Method (Comparative Example)

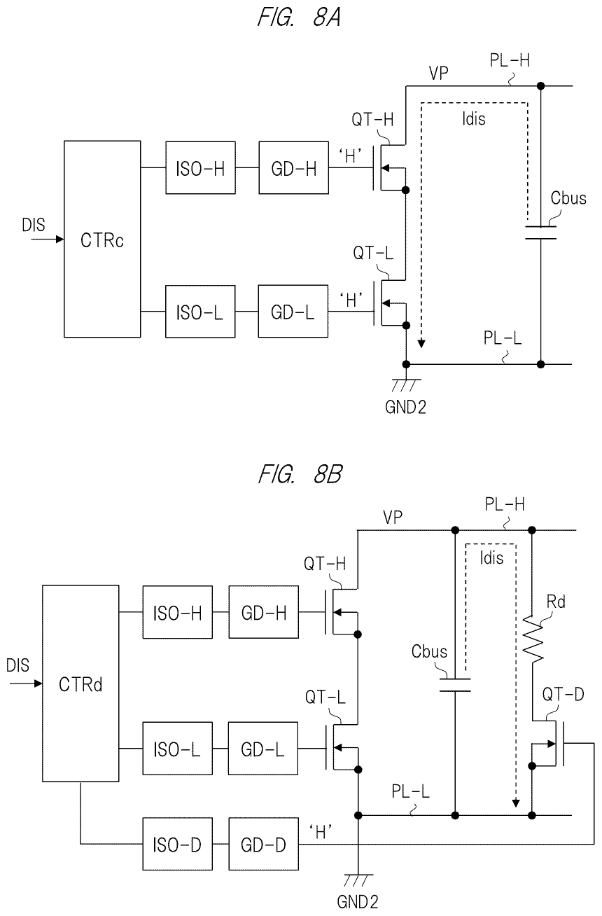

FIG. 8A is a schematic diagram illustrating an example of an active discharge method in the power conversion system according to a first comparative example. The power conversion system illustrated in FIG. 8A includes, as in the case of FIG. 1, a bus capacitor Cbus, power transistors QT-H and QT-L, gate drivers GD-H and GD-L, isolators ISO-H and ISO-L, and a controller CTRc. The controller CTRc controls both the power transistors QT-H and QT-L to an on state via the isolators ISO-H and ISO-L and the gate drivers GD-H and GD-L in response to a discharge instruction signal DIS.

Accordingly, the power conversion system can discharge the charge in the bus capacitor Cbus to the second ground voltage GND2 via the power transistors QT-H and QT-L in the on state. However, in the active discharge method, a large through-current flows through the power transistors QT-H and QT-L as a discharge current Idis. This may result in damage to the power transistors QT-H and QT-L. Also, gate drivers GD-H and GD-L with special functionality for active discharge may be required. For example, the gate drivers GD-H and GD-L include various protection functions to prevent a through-current in many cases. During active discharge, various such protection functions may need to be modified.

FIG. 8B is a schematic diagram illustrating an example of an active discharge method in the power conversion system according to a second comparative example. The power conversion system illustrated in FIG. 8B includes, as in the case of FIG. 1, a bus capacitor Cbus, power transistors QT-H and QT-L, gate drivers GD-H and GD-L, isolators ISO-H and ISO-L, and a controller CTRd. In addition to this, the power conversion system includes a resistive element Rd, a power transistor QT-D, a gate driver GD-D, and an isolator ISO-D that constitute an active discharge circuit.

The resistive element Rd and the power transistor QT-D are connected in series between the high-potential side power supply wiring PL-H and the low-potential side power supply wiring PL-L. The controller CTRd controls the power transistor QT-D to an on state via the isolator ISO-D and the gate driver GD-D in response to a discharge instruction signal DIS. Accordingly, the power conversion system can discharge the charge in the bus capacitor Cbus to the second ground voltage GND2 via the power transistor QT-D in the on state. However, such an active discharge method may result in increased costs due to the addition of an active discharge circuit.

### Active Discharge Method (Embodiment)

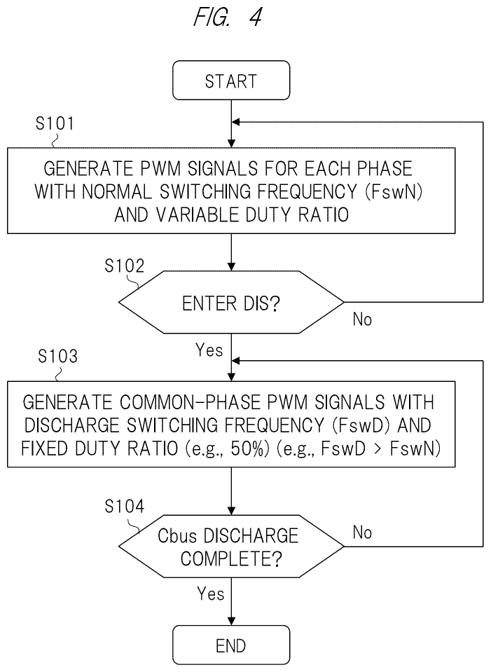

FIG. 4 is a flowchart illustrating an example of a schematic process of the controller CTR in FIG. 1 and FIG. 3. The flow illustrated in FIG. 4 is implemented, for example, by the processor PRC in the controller CTR executing the control program PRG stored in the memory MEM. However, the flow is not limited to this, and may also be implemented by, for example, the operation of various logic circuits constituting the controller CTR.

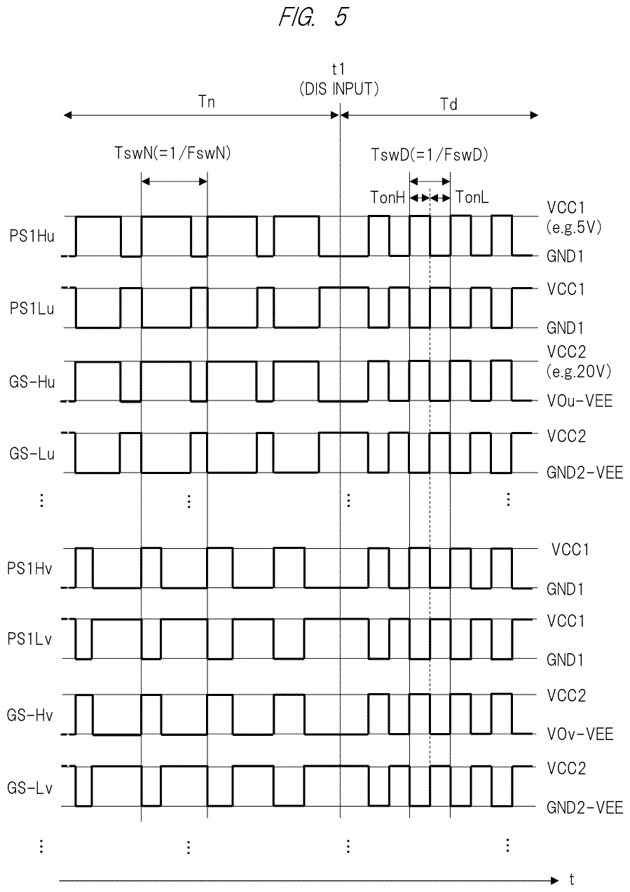

FIG. 5 is a supplementary diagram to FIG. 4, and is a timing chart illustrating an example of main signals transmitted within the power conversion system. FIG. 5 illustrates u-phase PWM signals PS1Hu and PS1Lu from the controller CTR, and gate drive signals GS-Hu and GS-Lu from the u-phase gate drivers GD-Hu and GD-Lu in FIG. 3. FIG. 5 further illustrates v-phase PWM signals PS1Hv and PS1Lv from the controller CTR, and gate drive signals GS-Hv and GS-Lv from the v-phase gate drivers GD-Hv and GD-Lv. In FIG. 5, signal transmission delay is ignored.

The PWM signals PS1Hu, PS1Lu, PS1Hv, and PS1Lv are signals that transition between the first ground voltage GND1 and the power supply voltage VCC1. The power supply voltage VCC1 is set to, for example, 5 V with reference to the first ground voltage GND1. Also, the gate drive signals GS-Hu and GS-Hv for the high side are signals that transition between a negative voltage (−VEE) with reference to the output voltages VOu and VOv, and the power supply voltage VCC2. The power supply voltage VCC2 is set to, for example, 20 V with reference to the output voltages VOu and VOv. On the other hand, the gate drive signals GS-Lu and GS-Lv for the low side are signals that transition between a negative voltage (−VEE) with reference to the second ground voltage GND2 and the power supply voltage VCC2.

In FIG. 4, during a normal operation period in which the discharge instruction signal DIS is not input (Step S102: No), the controller CTR generates and outputs the PWM signals PS1H and PH1L for each phase for normal operation (Step S101). The PWM signals PS1H and PH1L for the normal operation have a normal switching frequency FswN and a variable duty ratio. That is, as illustrated in FIG. 5, in the normal operation period Tn, a PWM period TswN based on the normal switching frequency FswN is used. Also, the duty ratio is set for each phase and for each PWM period TswN based on, for example, feedback control or the like.

Meanwhile, in FIG. 4, during the discharge period after the discharge instruction signal DIS is input (Step S102: Yes), the controller CTR generates and outputs common-phase PWM signals PS1H and PH1L for active discharge (Step S103). The PWM signals PS1H and PH1L for ctive discharge have a discharge switching frequency FswD which is different from the normal switching frequency FswN. Furthermore, the PWM signals PS1H and PH1L for active discharge have a fixed duty ratio, for example, a duty ratio of 50%.

Then, the controller CTR repeats the process of Step S103 until the discharge of the bus capacitor Cbus is completed (Step S104). In Step S104, the controller CTR may determine that the discharge is completed simply based on the length of the discharge period, without, for example, monitoring the power supply voltage VP.

During a discharge period Td illustrated in FIG. 5, a PWM period TswD based on the discharge switching frequency FswD is used. The discharge switching frequency FswD is higher than the normal switching frequency FswN, and is, for example, five or more times the normal switching frequency FswN. As a specific example, the normal switching frequency FswN and the discharge switching frequency FswD are 10 kHz and 100 kHz, respectively. Also, during the discharge period Td, unlike the normal operation period Tn, a common-phase PWM signal with a fixed duty ratio of, for example, 50% is generated.

That is, the controller CTR generates common-phase PWM signals (first PWM signals) PS1Hu and PS1Hv for the high side using the discharge switching frequency FswD and a fixed duty ratio, such as 50%. Also, the controller CTR generates common-phase PWM signals (second PWM signals) PS1Lu and PS1Lv for the low side. The PWM signals PS1Lu and PS1Lv for the low side are complementary signals to the PWM signals PS1Hu and PS1Hv for the high side.

The gate drivers GD-Hu and GD-Hv for the high side generate the gate drive signals GS-Hu and GS-Hv based on the PWM signals PS1Hu and PS1Hv for the high side. Similarly, the gate drivers GD-Lu and GD-Lv for the low side generate the gate drive signals GS-Lu and GS-Lv based on the PWM signals PS1Lu and PS1Lv for the low side.

As illustrated in FIG. 5, the PWM period TswD is composed of a high-side on-period TonH during which the power transistor QT-H for the high side is on, and a low-side on-period TonL during which the power transistor QT-L for the low side is on. Although not illustrated, a dead time is provided in each phase,—for example, in the gate drive signals GS-Hu and GS-Lu of the U phase—so that there is no overlap periods between the high-side on-period TonH and the low-side on-period TonL. The dead time is provided regardless of whether it is in the normal operation period Tn or the discharge period Td.

Moreover, the fixed duty ratio during the discharge period Td is not limited to 50% but may be any value equal to or greater than a few percent. For example, when the discharge switching frequency FswD is 100 kHz, the PWM period TswD is 10 μs. Details will be described below, but in the active discharge method according to the embodiment, it is sufficient that the lengths of the high-side on-period TonH and the low-side on-period (TonL) are each ensured to be, for example, approximately 40 ns or more based on “Ti”. This length can be ensured even if the duty ratio is 1%, that is, the high-side on-period TonH is 100 ns.

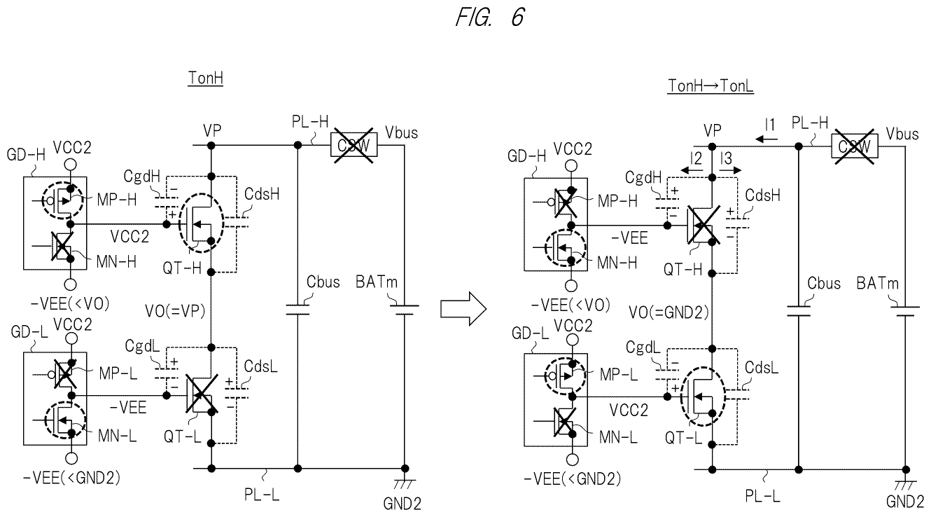

FIG. 6 is a schematic diagram illustrating the operation principle of active discharge performed during the discharge period Td in FIG. 5. FIG. 6 illustrates the power transistors QT-H and QT-L and the gate drivers GD-H and GD-L for one phase in FIG. 3, the bus capacitor Cbus, the contactor CSW, and the main battery BATm. FIG. 6 also illustrates the operation during the high-side on-period TonH in FIG. 5, and the operation during the transition period from the high-side on-period TonH to the low-side on-period TonL.

In FIG. 6, for example, when a collision is detected, the contactor CSW is turned off, thereby isolating the bus capacitor Cbus from the main battery BATm. Further, the power transistors QT-H and QT-L respectively have gate-drain parasitic capacitances CgdH and CgdL, and drain-source parasitic capacitances CdsH and CdsL. In the method of the embodiment, the parasitic capacitances CgdH, CgdL, CdsH, and CdsL are charged and discharged using high-speed switching control, thereby performing active discharge of the bus capacitor Cbus.

Specifically, first, during the high-side on-period TonH, the gate voltage of the power transistor QT-H is set to the power supply voltage VCC2 via the pMOS transistor MP-H which is in the on state. The output voltage VO is set to the power supply voltage VP via the power transistor QT-H which is in the ON state. Also, the gate voltage of the power transistor QT-L is set to the negative voltage (−VEE) via the nMOS transistor MN-L which is in the on state.

As a result, the parasitic capacitance CgdH is charged with the gate side of the power transistor QT-H as the positive electrode. The parasitic capacitance CdsH is not specifically charged. On the other hand, the parasitic capacitance CgdL is charged with the drain side of the power transistor QT-L as the positive electrode. The parasitic capacitance CdsL is charged with the drain side of the power transistor QT-L as the positive electrode.

A case is assumed in which a transition from the high-side on-period TonH to the low-side on-period TonL occurs in this state. The gate voltage of the power transistor QT-H is set to the negative voltage (−VEE) via the nMOS transistor MN-H which is in the on state. As a result, a current I2 flows from the high-potential side power supply wiring PL-H toward the parasitic capacitance CgdH. Also, the output voltage VO changes to the second ground voltage GND2 via the power transistor QT-L which is in the on state. As a result, a current I3 flows from the high-potential side power supply wiring PL-H toward the parasitic capacitance CdsH.

Accordingly, a current I1, which is the sum of the current I2 and the current I3, flows through the high-potential side power supply wiring PL-H. The current I1 is expressed by Equation (1) using the combined capacitance value Coss (=CgdH+CdsH) of the parasitic capacitance CgdH and parasitic capacitance CdsH and the slew rate (dv/dt) of the voltage change across the parasitic capacitances CgdH and CdsH. Note that Equation (1) is an equation for the case where the three-phase power transistors are controlled to be turned on or off simultaneously, as illustrated in FIGS. 3 and 5.

$$I 1 = cross \times ( dv / dt ) \times 3 \qquad ( 1 )$$

Also, assuming the time during which the current I1 flows is “Ti”, the average current Iave that flows through the high-potential side power supply wiring PL-H in one PWM period TswD is expressed by Equation (2). That is, the current I1 flows during the transition period from the high-side on-period TonH to the low-side on-period TonL, as well as during the transition period from the low-side on-period TonL to the high-side on-period TonH. In the latter period, the current I1 flows from the high-potential side power supply wiring PL-H toward the parasitic capacitances CgdL and CdsL via the power transistor QT-H in the on state.

$$Iave = I 1 \times ( Ti / TswD ) \times 2 \qquad ( 2 )$$

As a result, the discharge time Tdis required to reduce the power supply voltage VP to 60 V or lower is expressed by Equation (3). In Equation (3), “CBUS” represents the bus capacitance value of the bus capacitor Cbus. The bus capacitance value CBUS is typically 100 μF or more. “Vbus” represents the bus voltage of the main battery BATm, and is the initial value of the power supply voltage VP before discharging.

$$Tdis = CBUS \times ( V bus - 60 ) / Iave \qquad ( 3 )$$

For example, the following values may be given as representative numerical examples.

$$Coss = 1500 pF , dv / dt = 20 V / ns$$

$$Ti = 40 ns , TswD ( FswD ) = 10 μs ( 100 kHz )$$

$$CBUS = 500 μF , V bus = 800 V$$

Here, the current I1 based on Equation (1) is 90 A. The average current Iave based on Equation (2) is 360 mA. The discharge time Tdis based on Equation (3) is 1.0 s.

Accordingly, by performing switching control of the power transistors QT-H and QT-L using a high-speed switching frequency FswD of, for example, 100 kHz during the discharge period Td, active discharge can be completed in a discharge time Tdis of, for example, 1.0 s. This fully satisfies the standard requirements for active discharge, such as a discharge time of within 3.0 s. It should be noted that, even in the aforementioned numerical example, when the switching frequency FswD is, for example, 50 kHz, the requirement specification can still be satisfied. The discharge time Tdis in this case is 2.0 s.

Furthermore, a through-current (discharge current Idis) such as that illustrated in GIG. 8A does not flow during active discharge. Moreover, if the isolators ISO-H and ISO-L and the gate drivers GD-H and GD-L are capable of handling a high switching frequency FswD, it is not necessary, for example, to provide the gate drivers GD-H and GD-L with special functionality for active discharge. Furthermore, an additional active discharge circuit such as the one illustrated in FIG. 8B is also unnecessary. As a result, the bus capacitor Cbus can be safely discharged without increasing costs.

### Mounting Method (Comparative Example)

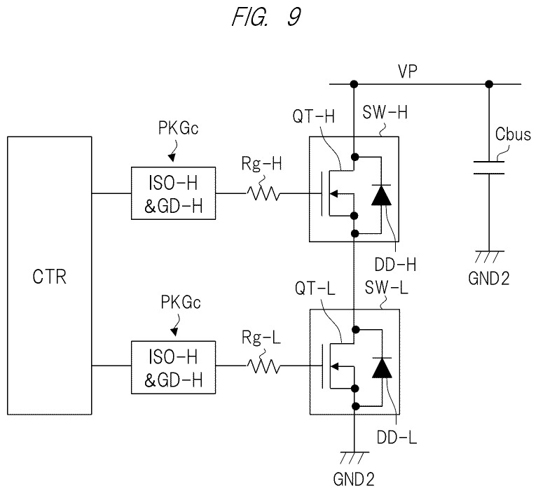

FIG. 9 is a schematic diagram illustrating an example of a mounting method in the power conversion system according to a third comparative example. In the power conversion system illustrated in FIG. 9, the isolator ISO-H and the gate driver GD-H for the high side are mounted in the same package PKGc. Also, the isolator ISO-l and the gate driver GD-L for the low side are mounted in the same package PKGc.

Here, to the package PKGc, in which the isolators ISO-H and ISO-L are mounted, a heat dissipation member such as a heat sink cannot be mounted due to insulation standards, specifically, the limitation on creepage distance. For this reason, for example, a Shrink Small Outline Package (SSOP) that does not have a heat sink is applied to the package PKGc. Meanwhile, the higher the switching frequency of the gate drivers GD-H and GD-L, the more heat they generate. For this reason, as mentioned above, when using the high-speed switching frequency FswD of, for example, 100 kHz, in order to dissipate heat from the package PKGc, it is necessary to provide gate resistive elements Rg-H and Rg-L outside the package PKGc, as illustrated in FIG. 9.

Here, in order to further improve heat dissipation, it is effective to increase the resistance values of the gate resistive elements Rg-H and Rg-L. However, as the resistance values increase, the slew rate decreases, so the applicable switching frequency decreases and the switching loss increases. For this reason, in the configuration illustrated in FIG. 9, it may not be feasible to ensure sufficient heat dissipation while increasing the applicable switching frequency.

### Mounting Method (Embodiment)

On the other hand, in the power conversion system PCS illustrated in FIG. 1, the gate driver GD-H and the isolator ISO-H for the high side are mounted in the separate packages PKGb and PKGa, respectively. Similarly, the gate driver GD-L and the isolator ISO-L for the low side are mounted in the separate packages PKGb and PKGa, respectively.

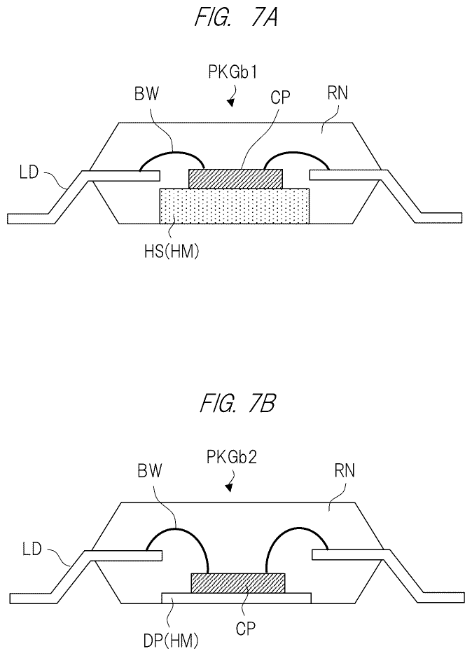

FIG. 7A is a cross-sectional view illustrating a configuration example of the package PKGb in which the gate drivers GD-H and GD-L are mounted in FIG. 1. FIG. 7B is a cross-sectional view illustrating a configuration example of the package PKGb different from that in FIG. 7A. Packages PKGb1 and PKGb2 illustrated in FIGS. 7A and 7B are, for example, Quad Flat Packages with Heat Sink (HQFPs). However, the packages PKGb1 and PKGb2 may also be Quad Flat Non-leaded Packages with Heat Sink (HQFN) or Very Thin Quad Flat Non-leaded Packages with Heat Sink (HVQFN), or the like.

The package PKGb1 illustrated in FIG. 7A includes a semiconductor chip CP, a heat sink HS, leads LD, bonding wires BW, and a resin RN that seals these elements therein. The heat sink HS is an example of a heat dissipation member HM. The heat sink HS is positioned such that a portion of a region thereof, specifically the region on the side mounted to the circuit board, is exposed to the outside. For example, the gate driver GD-H for the high side is formed on the semiconductor chip CP. The semiconductor chip CP is mounted on the heat sink HS. The bonding wires BW connect external terminals of the semiconductor chip CP to the leads LD.

The package PKGb2 illustrated in FIG. 7B has a configuration in which the heat sink HS in FIG. 7A is replaced with a die pad DP. The die pad DP, in other words, an Exposed PAD (ePAD), is another example of the heat dissipation member HM. The die pad DP, which is different from a typical die pad, is also positioned such that a portion of a region thereof, specifically the region on the side mounted to the circuit board, is exposed to the outside.

Accordingly, by providing the heat dissipation member HM, the allowable power loss of the packages PKGb1 and PKGb2 can be increased to, for example, around 5 W. On the other hand, the allowable power loss of the package PKGc that does not include a heat dissipation member HM is, for example, around 500 mW. Here, a power consumption Psw of the gate driver GD-H when the switching frequency FswD of 100 kHz is used is expressed by Equation (4). In Equation (4), it is assumed that a charge Qg for charging and discharging the gate of the power transistor QT-H is 2 μC, and that the power supply voltage VCC2 is 20 V. In this case, the power consumption Psw is 4 W.

$$Psw = FswD \times Qg \times V CC 2 \qquad ( 4 )$$

As described above, by mounting the gate drivers GD-H and GD-L and the isolators ISO-H and ISO-L in separate packages, it is possible to mount the heat dissipation member HM on the package PKGb in which the gate drivers GD-H and GD-L are mounted. As a result, sufficient heat dissipation can be ensured without using gate resistive elements Rg-H and Rg-L as illustrated in FIG. 9, while increasing the applicable switching frequency.

The gate resistive element (first resistive element) Rg-H is inserted in the transmission path of the gate drive signal GS-H for the high side. The gate resistive element (second resistive element) Rg-L is inserted in the transmission path of the gate drive signal GS-L for the low side. The gate resistive elements Rg-H and Rg-L may play a role in reducing switching noise by adjusting the slew rate of the gate drive signals GS-H and GS-L. From this point of view, as illustrated in FIG. 1, the gate resistive elements Rg-H and Rg-L may also be provided.

In this case, however, the resistance value of the gate resistive elements Rg-H and Rg-L may be, for example, less than 5 ohms, and even less than 2 ohms. That is, in the configuration illustrated in FIG. 9, the gate resistive elements Rg-H and Rg-L of about 5 ohms are provided to ensure heat dissipation assuming a normal switching frequency FswN, for example, 10 [kHz]. On the other hand, in a package in which the heat dissipation member HM, heat dissipation can be ensured even without providing the gate resistive elements Rg-H and Rg-L. Therefore, from the viewpoint of increasing the switching frequency while reducing switching noise, the gate resistive elements Rg-H and Rg-L of less than 5 ohms may also be provided.

### Major Effects of Embodiment

As described above, in the method of the embodiment, active discharge can be implemented by generating the PWM signals for the high side and the low side having a discharge switching frequency different from the normal switching frequency. This allows the bus capacitor to be safely discharged without increasing costs. Furthermore, in a power conversion system having isolators and gate drivers, by mounting the isolators and the gate drivers in separate packages, the discharge switching frequency can be increased while heat dissipation of the gate drivers is ensured. Accordingly, the discharge time of active discharge can be shortened.

In the foregoing, the invention made by the inventors of the present application has been concretely described on the basis of the embodiments. However, it is needless to say that the present invention is not limited to the foregoing embodiments, and various modifications and alterations can be made within the scope of the present invention. For example, the above-described embodiment has been described in detail to clearly explain the present invention, and is not necessarily limited to having all of the configurations described. Moreover, it is possible to replace part of the configuration of one embodiment with that of another embodiment, and it is also possible to add the configuration of another embodiment to that of one embodiment. Furthermore, with respect to parts of the configuration in each embodiment, it is possible to add to, delete from, or replace them with other configurations.

Furthermore, the above-mentioned program may be stored in a non-transitory tangible computer-readable recording medium and then supplied to a computer. Examples of such recording media include magnetic recording media represented by a hard disk drive, optical recording media represented by a Digital Versatile Disc (DVD) and a Blu-ray Disc, and semiconductor memory such as flash memory and a Solid State Drive (SSD).

What is claimed is:

1. An active discharge method in a power conversion system,
wherein the power conversion system includes
a first power supply wiring that supplies a high-potential side power supply voltage,
a second power supply wiring that supplies a low-potential side power supply voltage,
a bus capacitor connected between the first power supply wiring and the second power supply wiring,
a first power transistor connected between the first power supply wiring and an output node,
a second power transistor connected between the second power supply wiring and the output node,
a first gate driver that controls the first power transistor to perform switching control with a first drive signal based on a first PWM signal, and
a second gate driver that controls the second power transistor to perform switching control with a second drive signal based on a second PWM signal, and
wherein, during a discharge period after inputting a discharge instruction signal instructing discharge of the bus capacitor, the first PWM signal having a discharge switching frequency different from a normal switching frequency and the second PWM signal which is a complementary signal to the first PWM signal are generated for the first gate driver and the second gate driver.

2. The active discharge method according to claim 1,
wherein the discharge switching frequency is higher than the normal switching frequency.

3. The active discharge method according to claim 2,
wherein the discharge switching frequency is five or more times the normal switching frequency.

4. The active discharge method according to claim 1,
wherein, during the discharge period, the first PWM signal and the second PWM signal having a fixed duty ratio are generated.

5. The active discharge method according to claim 1,
wherein the power conversion system includes a plurality of phases,
wherein each of the plurality of phases includes the first power transistor, the second power transistor, the first gate driver, and the second gate driver, and
wherein, during the discharge period, the first PWM signals common to phases are generated for a plurality of the first gate drivers included in the plurality of phases, and the second PWM signals common to phases are generated for a plurality of the second gate drivers included in the plurality of phases.

6. A power conversion system comprising:
a first power supply wiring that supplies a high-potential side power supply voltage;
a second power supply wiring that supplies a low-potential side power supply voltage;
a bus capacitor connected between the first power supply wiring and the second power supply wiring;
a first power transistor connected between the first power supply wiring and an output node;
a second power transistor connected between the second power supply wiring and the output node;
a first gate driver that controls the first power transistor to perform switching control with a first drive signal;
a second gate driver that controls the second power transistor to perform switching control with a second drive signal;
a controller that generates a first PWM signal for the first gate driver and a second PWM signal for the second gate driver;
a first isolator that transmits the first PWM signal to the first gate driver while isolating the controller from the first gate driver; and
a second isolator that transmits the second PWM signal to the second gate driver while isolating the controller from the second gate driver,
wherein, during a discharge period after inputting a discharge instruction signal instructing discharge of the bus capacitor, the controller is configured to generate the first PWM signal having a discharge switching frequency different from a normal switching frequency and the second PWM signal which is a complementary signal to the first PWM signal.

7. The power conversion system according to claim 6,
wherein the discharge switching frequency is higher than the normal switching frequency.

8. The power conversion system according to claim 7,
wherein the discharge switching frequency is 50 kHz or higher.

9. The power conversion system according to claim 6,
wherein, during the discharge period, the controller is configured to generate the first PWM signal and the second PWM signal having a fixed duty ratio.

10. The power conversion system according to claim 6, further comprising:
a plurality of phases,
wherein each of the plurality of phases includes the first power transistor, the second power transistor, the first gate driver, and the second gate driver, the first isolator, and the second isolator, and
wherein, during the discharge period, the controller is configured to generate the first PWM signals common to phases for a plurality of the first gate drivers included in the plurality of phases, and the second PWM signals common to phases for a plurality of the second gate drivers included in the plurality of phases.

11. The power conversion system according to claim 6,
wherein the first gate driver and the first isolator are mounted in separate packages,
wherein the second gate driver and the second isolator are mounted in separate packages, and
wherein a package in which the first gate driver or the second gate driver is mounted includes a heat dissipation member that is positioned such that a portion of a region thereof is exposed to outside.

12. The power conversion system according to claim 11,
wherein a first resistive element is inserted in a transmission path of the first drive signal,
wherein a second resistive element is inserted in a transmission path of the second drive signal, and
wherein the resistance value of the first resistive element or the second resistive element is less than 5 ohms.

13. The power conversion system according to claim 6,
wherein the power conversion system is for use in a vehicle and includes
a battery that generates the high-potential side power supply voltage, and
a contactor that is inserted in a power supply path between the battery and the bus capacitor in the first power supply wiring, and
wherein, when detecting a collision, the vehicle controls the contactor to be turned off and outputs the discharge instruction signal to the controller.

14. The power conversion system according to claim 13,
wherein the high-potential side power supply voltage is 400 V or higher, and
wherein a capacitance value of the bus capacitor is 100 μF or more.
